(19) United States
(12) Patent Application Publication
(10) Pub. No.: US 2004/0041477 A1
(43) Pub. Date: Mar. 4, 2004

(54) Apparatus and self-locking mechanism for driving wiper components

(76) Inventors: Jochen Moench, Sinzheim (DE); Achim Neubauer, Sinzheim-Vormberg (DE); Martin-Peter Bolz, Buehl (DE); Hartmut Krueger, Buehlertal (DE)

Correspondence Address: STRIKER, STRIKER & STENBY, 103 East Neck Road, Huntington, NY, 11743, US

(21) Appl. No.: 10/464,403

(22) Filed: Jun. 18, 2003

(30) Foreign Application Priority Data
Aug. 30, 2002 (DE) 102 40 055.5

(51) Int. Cl. F16H 21/16; H02K 7/10

(52) U.S. Cl. 310/83; 15/250.003; 74/25

(57) ABSTRACT

The invention relates to a drive unit for wiper components on motor vehicles. The rive unit includes an electric drive (10), which is accommodated in a housing (3; 32, 33). The electric drive (1) includes an armature shaft (26), on which a first toothing (4) is formed. The armature shaft (26) is axially, displaceably accommodated in the housing (3; 32, 33) and is loaded via a spring element (28). On the housing (3; 32, 33), a crown wheel or a crown wheel segment (5) is pivotally accommodated. The crown wheel or crown wheel segment (5) meshes with the first toothing (4) on the armature shaft (26) of the electric drive (1).

### BACKGROUND OF THE INVENTION

With the wiper drives used today for front and back windows of motor vehicles, one arm wipers and/or counter direction wiper assemblies are used. This are provided with electric wiper drive motors. With counter direction wiper assemblies in today's embodiments, a linkage gear is necessary. On the basis of costs and space, however, the shaft of a windshield wiper is driven directly by a drive, whereby the drive only includes a cogwheel gear and an electric motor.

The wiper drives used today include an electric drive, which directly drives the shaft of a wiper via a cogwheel gear. In this connection, modified worm gears are used, which are adapted to the increased rotational moment specifications. A worm gear offers a self-locking feature, which makes inherent this gear principle based on its axial geometry. In addition, the use of a worm gear offers the possibility of preventing an unwanted movement of a wipe arm by wind and inertia forces. However, one disadvantage is that the worm gear has a substantial space requirement and in view of its manufacturing costs, is relatively expensive. A further characteristic inherent to the worm gear is its relatively minimal degree of efficiency, which, for causing a self-locking, lies below 50%.

U.S. Pat. No. 6,025,664 relates to an electric drive, which has a brake apparatus. The electric drive drives a gear, which includes helical cogwheels. The electric drive serves for operating of doors or gate elements. The electric drive includes an armature arranged on an armature shaft, which is encased by a stator fixedly arranged in a housing. Upon a current being applied to the electric drive, the armature rotates and drives a helical pinion accommodated on an armature shaft, which engages with a helical cogwheel. If the electric drive is not supplied with a current, a longitudinal displacement of the armature shaft takes place based on the axial force resulting from the helical gearing and acting on the armature shaft. On the end opposite to the helical end of the armature shaft, a conical brake ring is provided, which is non-rotatably accommodated on the armature shaft. With axial displacement of the armature shaft, the conical circumferential surface of the brake disk pressed against a conical region of the housing of the electric drive and brakes the rotating armature shaft. Thus, this is protected against rotation with an electric drive that is not supplied with current.

From U.S. Pat. No. 4,535,261, a small motor with reduction gears is known. In a shaft, a cogwheel and a disk enclosing the magnet core are accommodated on opposite ends of a shaft. The magnet core receives a magnetic coil, which can be supplied with current. If the magnetic coil is supplied with current, a downward movement of the shaft takes place with the cogwheel provided thereon, which engages with a further cogwheel, so that the rotational movement about a reduction gear is transferred. If the supply of current of the magnetic coil accommodated in the magnet core is interrupted, the disk for the magnet core accommodated on the opposite end of the shaft is thrust out, so that the cogwheel on the opposite end of the rotating shaft with the disk is moved upwardly and comes into an outer engagement with the cogwheel of the reduction gear. In this manner, the force flow in the reduction gear is interrupted.

DE 101 06 724 relates to a method and a device for decoupling of an actuator from a gear. The servo drive includes an electric actuator, which acts on the force transfer elements. With this, the adjusting movement on the drive or adjustment components to be adjusted is transferred. A disengaging element is provided, which breaks the force transfer through the force transfer elements in a current-less state of the electric actuator.

### SUMMARY OF THE INVENTION

According to the proposed solution, with the omission of a linkage gear, a direct drive for a wiper drive is realized, in that an electric drive cooperates with a crown wheel gear. In contrast to worm gears, with crown wheel gears, drive and output shafts intersect, or lie with helical gearing near one another. Thus, with a crown wheel gear, a substantially more compact construction of a direct wiper drive is possible.

Based on the arrangement of a crown wheel or a crown wheel segment directly on the electric drive, a further bearing point, as is necessary for stiffening or bracing of the worm gear shaft of a worm gear, can be eliminated. With worm gears, the support of the worm on the end remote from the drive motor is necessary for avoiding an improper bending of the worm under a load.

According to the proposed solution, the axis of rotation of the crown wheel or crown wheel segment is supported directly on the housing of the electric drive. In this manner, a favorable structural length of a direct drive for a wiper drive is provided. In addition, the width of the structural space for the wiper drive is reduced, so that this also can be built in with narrowed space dimensions. With the proposed variation of a direct drive for a wiper, a range of pivoting of more than 100° can be covered. The crown wheel or the crown wheel segment is preferably formed as an oval, in order to make possible a harmonic wiper movement and to assist in the high rotational moment required in the respective reverse position. In an advantageous manner, with using a crown wheel gear, an uneven gear reduction is very simply realized, since only the radius of the crown wheel or the crown wheel segment must be varied, so that the inner toothed crown wheel or crown wheel segment and an outer toothed pinion engaged on the shaft of the electric drive.

The length, in which the outer toothing of the pinion is formed on the armature shaft of the electric drive, can be changed easily according to manufacturing technology. With the use of a crown wheel or crown wheel segment with a minimized or enlarged radius, an exchange of the pinion on the electric drive is not necessary.

With the use of crown wheels or crown wheel segments, the gear reduction can be changed by variation of the toothing diameter and correspondingly adapted toothing. The smaller the toothing radius is, the smaller the gear reduction is. A variation of the radium of approximately 10% of a crown wheel segment, then leads to a greater gear reduction in the reverse position. With the same driving speed, a smaller rotational speed of the crown wheel segment is realized. The radius of the crown wheel or the crown wheel segment can be designed such that it is approximately 10% greater in comparison to the center radius of the crown wheel segment, with reference to the rotational point of the crown wheel segment on the lateral surfaces of the crown wheel segment. In this manner, a non-circular gear over a crown wheel drive can be represented, which is particularly suited for a wiper drive.

With the direct drive according to the present invention, a construction system for a direct drive is markedly simplified, that is, the number of structural components is reduced. The axis of rotation of the crown wheel or the crown wheel segment must not inevitably run at a right angle to the axis of symmetry of the electric drive. With predetermined application purposes, also other angles other than 90° between the armature shaft of the electric drive and the axis of rotation of the crown wheel or the crown wheel segment can be selected. This leads only to an exchange of the related crown wheel, not, however, the drive unit, which can remain unchanged. As an electric drive of the proposed direct drive for a wiper, a direct current motor is used, which is operated in an oscillating manner without linkage. The direct current motor requires no sensors for the commutator, rather an angle sensor for the drive is only necessary. Hall sensors or capacitive sensors can be used.

As an electric drive, a direct current motor is used, whose armature shaft together with the coils thereon and whose commutator accommodated on the armature shaft can be axially displaced with current actuation. The displacement of the armature shaft, the coils, and the commutator takes place in the state of no supplied current by an adjusting element, whose is formed as a spring. By means of the displacement of the armature shaft, a force or form-locking connection of the armature shaft with the housing of the electric drive is achieved. Upon supplying a current to the electric drive, the armature shaft can be moved again into its working position by means of the magnetic forces. Based on the crown wheel toothing, be it over a crown wheel or crown wheel segment of the drive cooperating with the electric drive, an axial displacement of the pinion formed on the armature shaft can take place without disturbing the tooth engagement by addition effects of force. Coupling elements or synchronization devices can be eliminated. In principle, the pinion section formed on the armature shaft of the electric drive can be axially displaced without separation of the tooth engagement to the crown wheel or crown wheel segment, if the pinion is formed in an adequate length on the armature shaft. If a straight toothing is chosen, an axial displacement of the armature shaft without rotation of the pinion and/or the crown wheel or crown wheel segment can take place. This favors a form or force-locking braking or locking of the armature shaft of the electric drive.

### BRIEF DESCRIPTION OF THE DRAWINGS

FIG. 1 shows an electric drive with a crown wheel or crown wheel segment accommodated rotatably thereon in a view from the rear and located in a center position;

FIG. 2 shows an electric drive according to FIG. 1 with a plan view on the toothing of the crown wheel or the crown wheel segment;

FIG. 3 shows an electric drive with a crown wheel segment that pivots about an axis of rotation;

FIG. 4 shows an electric drive according to FIG. 3, rotated at 1800 about its axis of symmetry;

FIG. 5 is a plan view of a crown wheel segment accommodated on a rotatable, electric drive;

FIG. 6 shows an activated self-locking device of an electric drive not supplied with current with a pinion on the armature shaft; and

FIG. 7 shows a non-activated self-locking device of the electric drive according to FIG. 6.

### DETAILED DESCRIPTION OF THE PREFERRED EMBODIMENTS

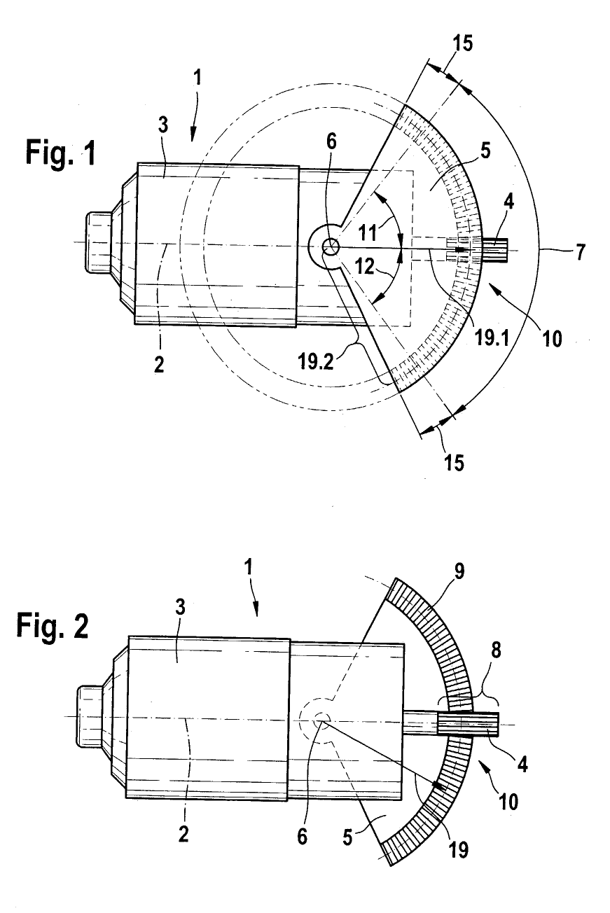

FIG. 1 shows an electric drive, on which a crown wheel or crown wheel segment is rotatably accommodated, which is located in this illustration in its center position. From the side view according to FIG. 1, a drive unit is shown, whose electric drive 1 is accommodated in a housing 3. Aligned to the axis of symmetry 2 of eh electric drive 1 and the housing 3 is an armature shaft having a first toothing 4. The first toothing 4 is preferably designed as a pinion and extends to an end region of the armature shaft of the electric drive 1. On a pivot point 6 on the outer side of the housing 3 of the electric drive, a crown wheel or a crown wheel segment 5 is pivotally accommodated. The pivot point 6 of the crown wheel or the crown wheel segment 5 represents the drive shaft of the drive unit shown in FIG. 1. A toothing formed on the inner side of the crown wheel or crown wheel segment and cooperating with the first toothing 4 on the armature shaft extends at an angle that is designated with reference numeral 7. The crown wheel or crown wheel segment 5 is shown in FIG. 1 in a center position 10. Above the center position 10—with reference to the axis of symmetry 2 of the electric drive 1—a first pivoting region 11 is designated, about which the crown wheel or the crown wheel segment 5 can be pivoted about its pivot point 6 on the housing 3 of the electric drive. Analogously, a second pivoting region 12 extends below the axis of symmetry 2 of the electric drive 1, about which the crown wheel or the crown wheel segment 5 can be moved downwardly. In the end regions 15 of the crown wheel or the crown wheel segment 5, stopping regions 15 of the toothing on the inner side of the crown wheel or crown wheel segment 5 are formed. The stopping regions 15 provided on the crown wheel or crown wheel segment 5 can be used in the frame of an electronic wiper control, for example, in order to realize a park position, which only is initiated when the wiper assembly is switched off. If a changing demand on the window occurs, such as, for example, a dry window surface, a wet window surface, or different wiper speeds, in the frame of an electronic control, the wiper assembly can be used over the stopping regions 115 on the crown wheel segments 5 depending on the window condition of the complete wiper range. So, for example, with high wiper resistances, for example, a dry window, the crown wheel or the crown wheel segment 5 can be rotated so far that also the stopping region 15 are positioned in the engagement region of the first toothing 4. In this manner, also with large resistances, the entire wiper region can be swiped. Whereas a small angle of rotation is necessary with large centrifugal forces with a high wiper speed level and a wet window, by means of the electronic wiper control, a movement of the crown wheel segment 5 in its stopping region 15 can be prevented by a corresponding control of the electrical drive 1.

FIG. 2 is the drive unit according to FIG. 1 with the plan view of the inner toothing of the crown wheel or the crown wheel segment.

On the side of the crown wheel or crown wheel segment 5 facing the first toothing 4 on the armature shaft of the electric drive 1, a toothing 9 is provided. The radius of the center line of the toothing 9 with reference to the pivot point 6 of the crown wheel or the crown wheel segment 5 is designated with reference numeral 19. By the selection of the radius 19 of the crown wheel or the crown wheel segment 5, the pivoting path of the drive axis coinciding with the pivot point 6 of the crown wheel or crown wheel segment 5 can be predetermined or varied. The first toothing 4 on the shaft of the electric drive 1 is preferably formed as a pinion, which is formed within a toothing region 8 extending in the axial direction on the armature shaft of the electric drive 1. Also in FIG. 2, the crown wheel or the crown wheel segment 5 is located in its center position, designated with reference numeral 10.

In the representation according to FIGS. 1 and 2, the axis of the pivot point 6 of the crown wheel or the crown wheel segment 5 intersects with the armature shaft of the electric drive 1, on which the first toothing 4 is formed. With the embodiment shown here of a drive unit, pivoting paths of the crown wheel or crown wheel segment 5 of approximately 110° can be achieved. Depending on the materials, lubricants and environments conditions used to which the drive unit is exposed, merely one housing 1 surrounding the electric drive 1 is necessary. In this case, an encapsulation of the gears from the crown wheel or crown wheel segment 5 and the first toothing 4 on the armature shaft of the electric drive 1 is not necessary.

Alternatively, depending on the conditions of use of the drive unit, also the gear components 5 or 4 can be protected by means of a housing (not shown in FIGS. 1 and 2).

The crown wheel or crown wheel segment 5 shown in FIGS. 1 and 2 has an oval shape, in order to support a harmonic wiper movement and to aid in applying the high rotational moment required to bring a wiper into the reverse position. Thus, the crown wheel or the crown wheel segment 5 has a first crown wheel radius 19.1 in its center, which coincides with the axis of symmetry 2 in FIG. 2, the radius being smaller than the radius 19.2 of the crown wheel or the crown wheel segment 5 at its transverse ends, respectively, with reference to the center of the toothing 9 on the crown wheel or the crown wheel segment 5.

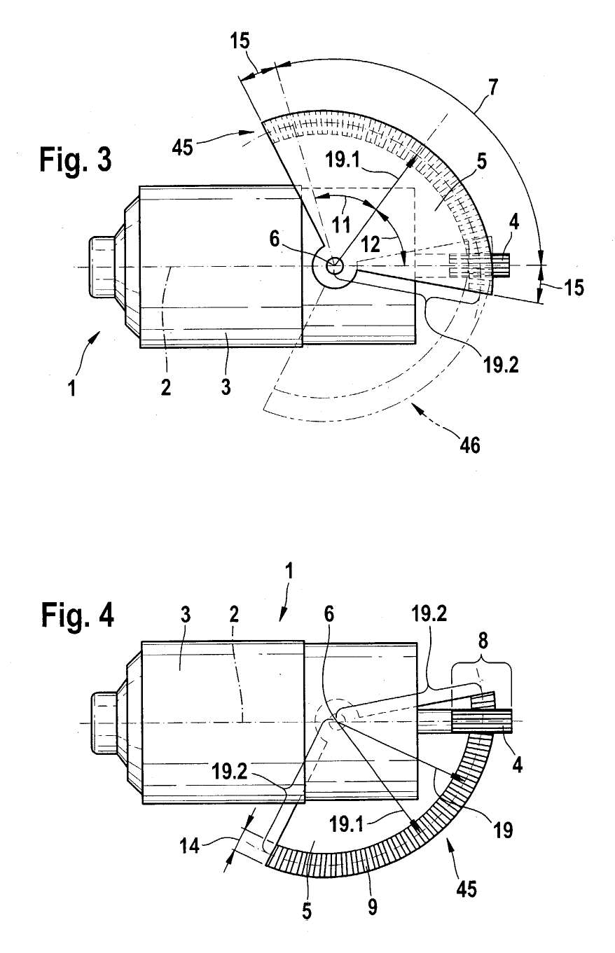

FIG. 3 shows an electric drive with a crown wheel or crown wheel segment pivoted about its pivot point.

From FIG. 3, it can be seen that the crown wheel or the crown wheel segment 5 is shown in its first end position 45. In this position, the first toothing 4 of the armature shaft of the electric drive 1 of the drive unit and the toothing 9 formed on the inner side of the crown wheel or the crown wheel segment 5 are engaged. With reference to the center position 10 shown in FIG. 1, the crown wheel or the crown wheel segment 5 is set on its entire surface 7 in the first end position 45. The second end position 46 of the crown wheel or the crown wheel segment 5 is shown in a dashed illustration, into which this is placed upon reversing of the electric drive 1 of the drive unit. The effective pivoting range, about which the crown wheel or the crown wheel segment 5 is pivotable during the rotational movement of the electric drive 1 with maintenance of the tooth engagement between the first toothing 4 and the toothing 9 of the crown wheel gear or the crown wheel segment 5, is composed of the first pivoting region 11 and the second pivoting region 12 together.

Through the selection of asymmetrical crown wheel segments, the rotational angle ranges can be adjusted, which amount to approximately 180° with back wipers and with front windshield wipers, permit a maximum of 60° wiper rotation, in particular, on the passenger side. The end sections of the crown wheel or the crown wheel segment 5 are identified with reference numeral 15. The stopping regions 15 on the crown wheel segment 5 can be used with an electronic control of the wiper assembly, such that with dry windows, which represent a high wiper resistance, it can be ensured that the wiper components swipe over the entire wiper range. Based on the adjusting elasticity in the wiper lever or wiper blade, greater frictional forces are to be overcome with dry window surfaces, which cannot reach a completed end position of a wiper arm. If with such environment conditions of the electric drive 1, which drives the crown wheel segment 5 until it is in its stopping regions 15, the adjusted elasticity of the wiper arm or wiper lever and wiper blade with dry window surfaces can be compensated, and a complete over-swiping of the wiping range can be ensured. With high wiper speed and a wet window, it can be necessary to control the electric drive 1 such that the angle or rotation of the crown wheel segment 5 is dimensioned so that they are not regulated in the stopping regions 15 lying in the stopping regions, and as a result, a smaller angle of rotation is achieved. This is a particular goal, when the wiper assembly works at higher speeds and the wiper lever or wiper arm, and the wiper blade accommodated thereon, are subject to high centrifugal forces.

FIG. 4 shows the drive unit according to FIG. 3, which is rotated 180° about its axis of symmetry.

From FIG. 4, it can be seen that the crown wheel or crown wheel segment 5 accommodated on the housing 3 of the electric drive 1 is shown in its first end position 45, based on the rotation of the drive unit about its axis of symmetry 2 lying hereunder. Based on the formation of the first toothing 4 as a pinion within a toothing region 8 on the end of the armature shaft of the electric drive 1, the tooth engagement between the teeth of the first toothing 4 and the toothing 9 on the inner side of the crown wheel or the crown wheel segment 5 corresponding to its radii 19.1, 19.2, 19.3 moves in the axial direction with reference to the toothing region 8. The toothing length is designated with reference numeral 14, in which the toothing 9 are formed on the inner side of the crown wheel segment 5. This is favorable for the achievement of a harmonic wiper movement and permits the elimination of possible multi-joint linkage adapted to the wiper movement.

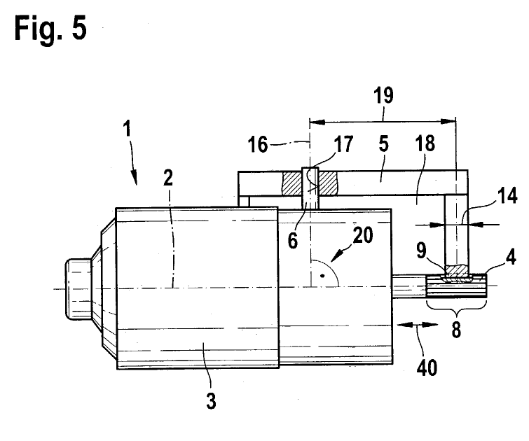

FIG. 5 shows a plan view of a rotatable crown wheel or crown wheel segment on the drive unit.

From the plan view according to FIG. 5, it can be seen that the axis of symmetry 2 of the electric drive 1 of the drive unit is aligned with the armature shaft, on which, within the toothing region8, the first toothing 4 in the form of a pinion is formed. The axis of rotation 16 of the crown wheel or crown wheel segment, which coincides with the pivot point 6, runs perpendicular to this. The axis of rotational 15 penetrates a bore 17 in the crown wheel segment 5, whose inner space is designated with reference numeral 18. With reference to the center of the toothing 9 of the crown wheel or crown wheel segment 5, the crown wheel or crown wheel segment 5 has a radius 19, which, according to FIGS. 3 and 4, varies between an effective radius 19.1 in the center and 19.2 on the edges of the crown wheel or crown wheel segment. Based on the center radius 19 of the crown wheel or crown wheel segment 5, the desired uneven gear reduction is adjusted in a very simple manner. A change of the desired uneven gear reduction can therefore be provided, in that instead of a crown wheel or crown wheel segment with a predetermined radius, a crown wheel or crown wheel segment 5 with another radius is mounted on the pivot point 6, which coincides with the rotational axis 16 of the crown wheel or crown wheel gear 5. Since the first toothing 4 is formed in the toothing region 8 on the end of the shaft of the electric drive 1 in a larger axial length, also a crown wheel or crown wheel segment 5 with inner toothing 9 and a different radius meshes with the first toothing 4. This is set forth in the toothing length 14, which here, is smaller than the axial length of the toothing region 8.

If the radius 19.2 on the edges of the crown wheel or crown wheel segment 5 are selected to be enlarged by 10% with reference to the radius 19.1 of the crown wheel segment 5, a larger gear reduction in the reverse position of a wiper drive and with the same drive rotational speed, a smaller rotational speed of the crown wheel, are realized. In this manner, a non-circular drive can be represented with a crown wheel drive in a simple manner, which is particularly suited for a wiper drive.

As shown in FIG. 5, if there is a right axis angle 20 between the axis of rotation 16 of the crown wheel or the crown wheel segment 5, which coincides to the pivot point 6, and the armature shaft of the electric drive 1, which here coincides with the axis of symmetry 2, then also angels 20, other than right angles, between the axis of rotation 16 and the armature shaft of the electric drive 1 can be chosen. If other angles than right angels as the axis angle 20 between the axis of rotation 16 and the armature shaft of the electric drive 1 are necessary, based on crowded structural dimensions for reasons of external realities, then this circumstance sustains a calculation that with maintenance of the electric drive 1, merely a modified crown wheel or crown wheel segment 5 is provided on the pivot point 6 on the outer side of the housing 3. The electrical machines used as electric drives 1 operated preferably as reversibly operatable direct current motors. The reversible direct current motors require no sensor for commutation; merely, an angle sensor for the detection of the positions of the drive is required on the crown wheel or crown wheel segment 5. The drive shaft of the crown wheel or the crown wheel segment 5 coincides with the pivot point 6 of with its axis of rotation 16 on the outer side of the housing 3 of the electric drive 1. As angle sensors for detection of the rotational position of the drive shaft of the crown wheel or crown wheel segment 5, Hall sensors or capacitive sensors can be used.

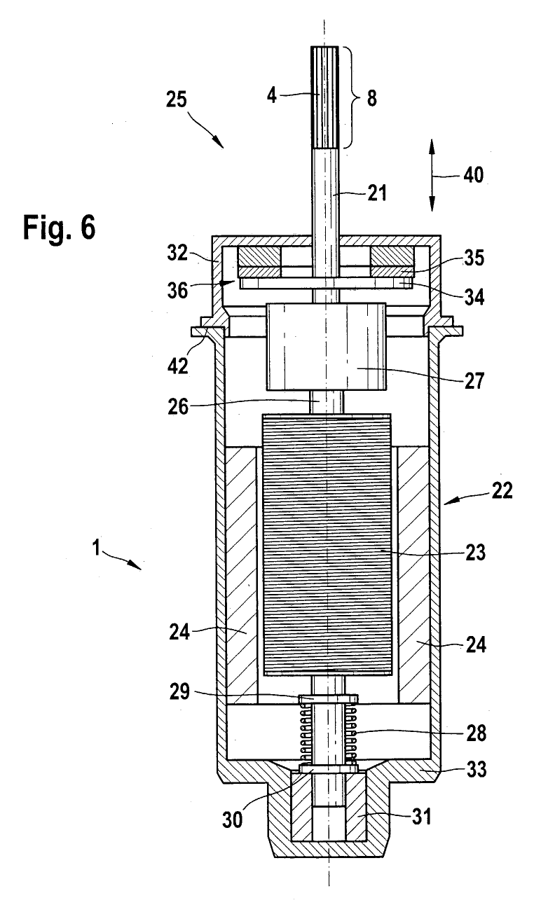

FIG. 6 shows a drive unit for wiper components with an activated automatic locking device.

From FIG. 6, it can be seen that the electrical drive 1 illustrated there includes a divided housing 32, 33. The housing halves 32 or 33 lie on one another along an expansion joint and can be connected to one another by screws or vie clamping connections. On the inner side of the second housing half 33 of a pole cover housing 22 of the electric drive 1, permanent magnets are provided on the stator side. The permanent magnets 24 on the inner side of the second housing half 33 surround an armature coil 23, which is accommodated non-rotatably on the armature shaft 26 of the electric drive 1. A commutator 27 is provided at a distance to the front side of the armature coil 23 on the armature coil 23. The armature shaft 26 of the electric drive 1 is supported on the one hand in the first housing half 32 of the divided pole cover housing 22, and on the other hand, in a shaft bearing 31, which is provided within the second housing half 33 of the divided pole cover housing 22. The armature shaft 26 of the electric drive is formed, such that it is displaceable within the axial bearing 31 provided in the second housing half 33. On the end of the armature shaft 26 accommodated in the second housing half 33, a spring element 28 is provided. The spring element 28 is braced, on the one hand on a first ring 29 that is fixed in the axial direction, and on the other hand, on a second ring 30, which is provided in the axial direction displaceably on the armature shaft 26 of the electric drive. On the armature shaft 26 of the electric drive 1, a butting ring 34 is provided. This is connected fixedly with the armature shaft 26 cooperates with a contact surface 35 surrounded by the second housing half 32.

On the end of the armature shaft 26, which is encompassed by the axial bearing 31 within the second housing half 33 of the divided pole cover housing 22, an axial bearing can be provided for avoiding friction and for absorbing the forces occurring with the axial displacement of the armature shaft 26. The axial bearing can be provided on the front side 3 of the sleeve-shaped axial bearing 31 facing the second ring 30.

In the state 25 of the electric drive 1 of the drive unit when it is supplied with current shown in FIG. 6, of which only the housing and the first toothing 4 are shown in FIGS. 1 through 5, the armature coil 23 of the armature shaft 26 is not supplied with current. In this state, only one force operates, with which the ferromagnetic laminated core retains in position the armature coil 23 of the permanent magnets 24, which surround the armature coil 23. The spring force of the spring element 28 is dimensioned such that it overcomes the force acting by means of the ferromagnetic laminated core in a state of not being supplied with current. On this bases, the armature shaft 26 is pressed into the first housing half 32 of the divided pole cover housing 22 by the action of the spring element 28 with its butting ring 23. As a result, a frictional connection is formed between the butting ring 35 and the support surface 35. During the axial movement, designated with the double arrow 40, the crown wheel or crown wheel segment 5—not shown in FIG. 6—remains engaged with the first toothing 4 of the armature shaft 26, which extends over a toothing region 8, which is formed on a pinion shaft 21. A disengagement of the first toothing 4, preferably formed as a pinion, from the toothed engagement with the toothing 9 on the inner side of the crown wheel or the crown wheel segment does not occur.

By means of the axial movement corresponding to the path 40, the butting ring 34 non-rotatably attached on the armature shaft 26 is pressed on the contact surface 35. Based on the occurring frictional connection 36, a rotational movement of the armature shaft 26 within the divided pole cover housing 22 is prevented.

Instead of the frictional contact between the butting ring 34 and the contact surface 35 on the housing side shown in FIG. 6, also a form-locking connection can be formed between the butting ring 34 and the contact surface 35. This can be achieved by means of a toothing. A toothing connection, that is, a form-locking connection between the butting ring 34 and the contact surface 35 n the interior of the pole cover housing 22, reduces in an advantageous manner the magnitude of the axial forces to be produced. By means of the selection of the tooth flank angle, the proportion of the axial blocking force to a blockable moment of rotation can be adjusted. Since with an increasing tooth flank angle, the release of the connection and the rotational moment load is heavier, upon the releasing, an assured release must be attended to. If no meshing of the gear wheels upon switching off the current is possible with the design of a force-fluid connection between the butting ring 34 and the contact surface 35 in the interior of the pole cover housing 22 based on the tooth geometry, this can be made possible by means of minimal tooth distances with a small angular offset, caused by the outer forces of by the axial forces. A large number of teeth and small tooth geometry are favorable.

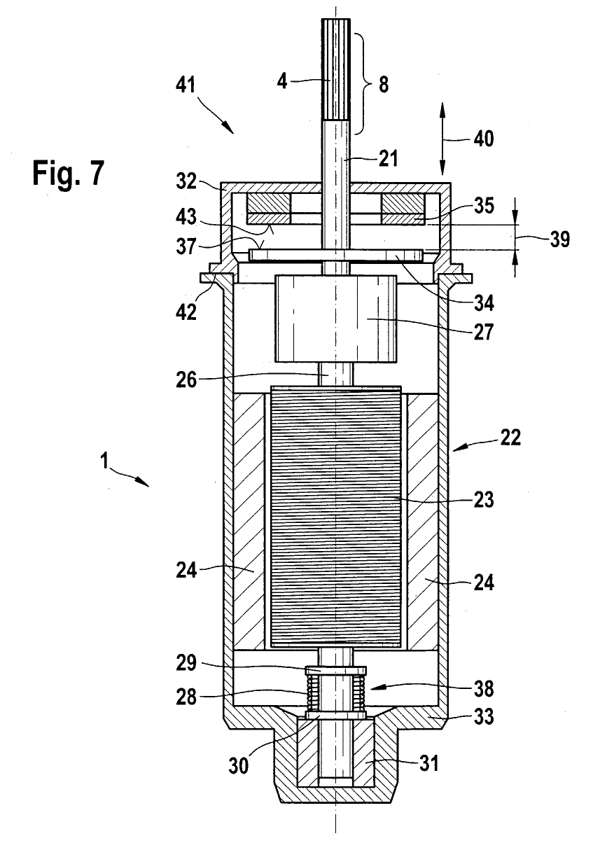

FIG. 7 shows a non-activated automatic, or self-locking, device of an electrical drive of the drive unit of the present invention.

From the illustration according to FIG. 7, it can be seen that in a state in which the armature coil 23 of the armature shaft is supplied with a current, based on the formed magnetic field of the armature coil 23, an axial force is produced, which overcomes the force of the tensioned spring element 28. In this manner, the armature coil 23 is reached between the permanent magnets 24, which surrounds the armature coil 23 on the inner side of the second housing half 33. These positions of the armature shaft 26 of the armature coil 23 of the electrical drive 1 are maintained also with each reversal, that is, with each reverse moment of rotation of the electric drive 1, the electromagnetic field does not breakdown. In a state 41 having a current, the butting ring 34 non-rotatably provided on the armature shaft 23 is readjusted to a split mass 39 from the contact surface 35. The split mass 39 is positioned between the side 37 facing the contact surface 35 of the butting ring and an annular surface 43 of the contact surface 35. In the state of being supplied with current of the armature coil 23 of the electric drive, the spring element 28 has a compressed state 38, so that the end opposite to the first toothing 4 is reset completely in the sleeve-shaped axial bearing 31 in the second housing half 33. This sleeve-shaped axial bearing 31 is dimensioned, such that this accommodated without a problem the existing in-movement with the axial displacement of the armature shaft 26 according to the path 40. In a compressed state 38 of the spring element 28, this can be pressed together until a block length and lies with its respective ends on the first ring 29 and on the second ring 30, which is displaced on the armature shaft 26. As already mentioned in connection with FIG. 6, beneath the second ring 30 on the side facing the sleeve-shaped axial bearing 31, an axial bearing preventing friction can be provided.

The use of an electric drive 1 having a self-locking or automatic device with a crown wheel or crown wheel segment 5 according to FIGS. 1 through 5 permits an avoiding of an unwanted movement of a wiper arm component based on the active wind and inertia forces. The electric drive 1, on which the crown wheel or the crown wheel segment 5 is directly accommodated permits a displacement of the armature shaft 26 and likewise, of the commutator 27 with the switching off of the current. In a current-less state 25, a force of form-locking connection 36 of the armature shaft 26 with the pole cover housing 22 is achieved by a butting ring 34 cooperating with a contact surface 35. The blocking of the rotational movement of the armature shaft 26 in a current-less state 25 of the electric drive 1 can either take place in a form-locking or force-locking manner. With renewed current, that is a state of the electrical drive with current 41, the armature shaft 26 moves by means of the magnetic forces produced from the armature coil 23 again into its working position between the permanent magnets 24 arranged on the inner side of the pole cover housing 22, whereby the force or form-locking connection 36 between the butting ring 34 and the contact surface 35 within the pole cover housing 22 is again nullified Based on the use of a crown wheel or a crown wheel segment 5, the axial displacement of the armature shaft 26 according to the path 40 can take place without disturbing the tooth engagement or without additional action of force, so that coupling elements or a synchronization device are dispensable. If the inner toothing 9 of the crown wheel or the crown wheel segment 5 and the first toothing 4, for example, a pinion, are designed as straight teeth, a disengagement of the first toothing 4 formed as a pinion in the toothing region8 of the armature shaft 26 from the toothing 9 of the crown wheel or crown wheel segment 5 is prevented.

The inventive drive unit, an electrical drive 1 including a displaceable armature shaft 26, as well as the crown wheel or crown wheel segment 5 pivotally supported on the housing of the electrical drive 1 makes possible a use of a gearing with a high degree of efficiency. Therefore, on the one hand, a minimization of the drive load, as well as a minimization of the structure volume of the drive unit are possible, and on the other hand, a linkage gearing can be eliminated. The self-locking in the current-less state 25 of the electrical drive 1 takes place based on the axial displacement of the armature shaft 26, whereby, however, the tooth engagement within the gears 4, 5 is maintained.

It will be understood that each of the elements described above, or two or more together, may also find a useful application in other types of constructions differing from the types described above.

While the invention has been illustrated and described herein as an apparatus and self-locking mechanism for driving wiper components, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A drive unit for wiper components on motor vehicles with an electric drive (1), which is accommodated in a housing (3; 32, 33) and includes an armature shaft (26) with an armature coil (23), on which a first toothing (4) is formed, and the armature shaft (26) is accommodated in the housing (3; 32, 33) such that the armature shaft (26) can be displaced in an axial direction (40), wherein the armature shaft (26) is pretensioned by means of a spring element (28), characterized in that on the housing (3; 32, 33) of the electric drive (10), a crown wheel or crown wheel segment (5), which engages with the first toothing (4) on the armature shaft (26), can be pivoted about an axis of rotation (16).

2. The drive unit according to claim 1, characterized in that the axis of rotation (16) of the crown wheel or the crown wheel segment (5) on the housing (3; 34, 33) forms a drive axis of the drive unit.

3. The drive unit according to claim 1, characterized in that the first toothing (4) on the armature shaft (26) is formed in a toothing length, which corresponds to a path (40) within which the armature shaft (26) is axially displaceable within the housing (3; 32, 33).

4. The drive unit according to claim 1, characterized in that the first toothing (4) on the armature shaft (26) is embodied as a pinion.

5. The drive unit according to claim 1, characterized in that the crown wheel or crown wheel segment (5) has a toothing (9) opposite to the first toothing (4) on the armature shaft (26).

6. The drive unit according to claim 5, characterized in that the first toothing (4) of the armature shaft (26) and the toothing (9) of the crown wheel or the crown wheel segment (5) are embodied as a straight toothing.

7. The drive unit according to claim 1, characterized in that the axis of rotation (16) of the crown wheel or the crown wheel segment (50) and the armature shaft (26) of the electric drive (1) run at an angle to one another.

8. The drive unit according to claim 7, characterized in that the axis of rotation (16) of the crown wheel or the crown wheel segment (5) and the armature shaft (26) of the electric drive (1) are arranged at a right angle (20) to one another.

9. The drive unit according to claim 7, characterized in that the axis of rotation (16) of the crown wheel or crown wheel segment (5) and the armature shaft (26) of the electric drive (10) are arranged at an angle of 45° maximum, preferably between 15° and 20°.

10. The drive unit according to claim 1, characterized in that the crown wheel or the crown wheel segment (5) is formed as an oval, wherein the outer radius (19.2) of the crown wheel or crown wheel segment exceeds a radius (19.1) lying in a line of symmetry of the crown wheel or the crown wheel segment (5).

11. The drive unit according to claim 1, characterized in that the crown wheel or the crown wheel segment (5) can be pivoted in both directions about identical pivoting regions (11, 12), with reference to a center position (10) of the crown wheel or crown wheel segment (5).

12. The drive unit according to claim 11, characterized in that in the end positions (45, 46) of the crown wheel or crown wheel segment (5), the pivoting regions (11, 12) with reference to the axis of symmetry of the electric drive (1) are respectively added together.

13. The drive unit according to claim 1, characterized in that in the housing (3; 32, 33) of the electric drive (10), a contact surface (35) is formed, which cooperates with a butting ring (34) non-rotatably arranged on the armature shaft (26) with the axial displacement of the armature shaft (26) to the path (40).

14. The drive unit according to claim 13, characterized in that with an axial displacement of the armature shaft (26) and the path (40), the tooth engagement between the first toothing (40) on the armature shaft (26) and the toothing (9) of the crown wheel or the crown wheel segment (5) is maintained.

15. The drive unit according to claim 13, characterized in that in a state of having no current supply (26) to the electric drive (1), the butting ring (34) engages the armature shaft (26) by means of the spring element (28) in a frictional manner (36) or in form-locking manner on the contact surface (35) of the housing (3; 32, 33).

16. The drive unit according to claim 13, characterized in that in a state (41) of the electric drive (1) being supplied with current, the armature coil (23) of the armature shaft (26) is set against the force of the spring element (28) in a stator coil (24) of the electric drive (1) and the butting ring (34) is separated from the contact surface (35) of the housing (3; 32, 33).

17. The drive unit according to claim 16, characterized in that with a reversal of the direction of rotation of the electric drive (1) between the end positions (45, 46) and the crown wheel or the crown wheel segment (5), the butting ring (34) remains separated from the contact surface (35) of the housing (3; 32, 33).
